(19) United States
(12) Patent Application Publication
(10) Pub. No.: US 2017/0265501 A1
(43) Pub. Date: Sep. 21, 2017

(54) Method and Apparatus for Batch Processing of Chicken Parts

(71) Applicant: OSI Industries, LLC, Aurora, IL (US)

(72) Inventors: BK Girdhar, Oak Brook, IL (US); Edwin Palang, San Mateo, CA (US); Otoniel Chavez, Maywood, IL (US)

(21) Appl. No.: 15/453,611

(22) Filed: Mar. 8, 2017

Related U.S. Application Data
(60) Provisional application No. 62/308,564, filed on Mar. 15, 2016.

(51) Int. Cl. A23L 5/10; A23L 13/00

(52) U.S. Cl. CPC A23L 5/10; A23L 13/00; A23V 2002/00

(57) ABSTRACT

A method for cooking a batch of chicken pieces is disclosed including the steps of: (1) providing a plurality of chicken pieces at about 40° F., (2) submerging the plurality of chicken pieces in a first heated water bath until a portion of the outer surface of the chicken pieces is denatured, (3) placing the plurality of opaque chicken pieces into a flexible pouch; (4) applying vacuum to the flexible pouch and sealing the pouch to form a sealed container, and (5) submerging the sealed container in a second heated water bath at a temperature of from about 135° F. to about 195° F. for an effective period of time to fully cook the chicken pieces.

### CROSS-REFERENCE TO RELATED APPLICATIONS

The present application claims the benefit of U.S. Provisional Application No. 62/308,564 filed Mar. 15, 2016, the contents of which are incorporated herein by reference.

### FEDERALLY SPONSORED RESEARCH OR DEVELOPMENT

N/A

### FIELD OF THE INVENTION

A method and apparatus for batch processing of large quantities of chicken parts is disclosed and described.

### BACKGROUND OF THE INVENTION

Processing large batches of chicken pieces by cooking in vacuum sealed flexible bags has presented difficulties as the pieces had the tendency to stick together after cooking was complete making it difficult to use the individual pieces.

### SUMMARY OF THE INVENTION

A method for cooking a batch of chicken pieces is disclosed including the steps of: (1) providing a plurality of chicken pieces at about 40° F., (2) submerging the plurality of chicken pieces in a first heated water bath until a portion of the outer surface of the chicken pieces is denatured, (3) placing the plurality of the denatured chicken pieces onto a flexible sidewall of a flexible pouch; (4) applying vacuum to the flexible pouch and sealing the pouch to form a sealed container, and (5) submerging the sealed container in a second heated water bath at a temperature of from about 135° F. to about 195° F. for an effective period of time to fully cook the chicken pieces.

### BRIEF DESCRIPTION OF THE DRAWINGS

To understand the present invention, it will now be described by way of example, with reference to the accompanying drawings in which:

FIG. 1 is a list of steps in the process of the present invention.

FIG. 2 is an isometric view of a top layer of a pouch.

FIG. 3 is an isometric view of a bottom layer of a pouch.

### DETAILED DESCRIPTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

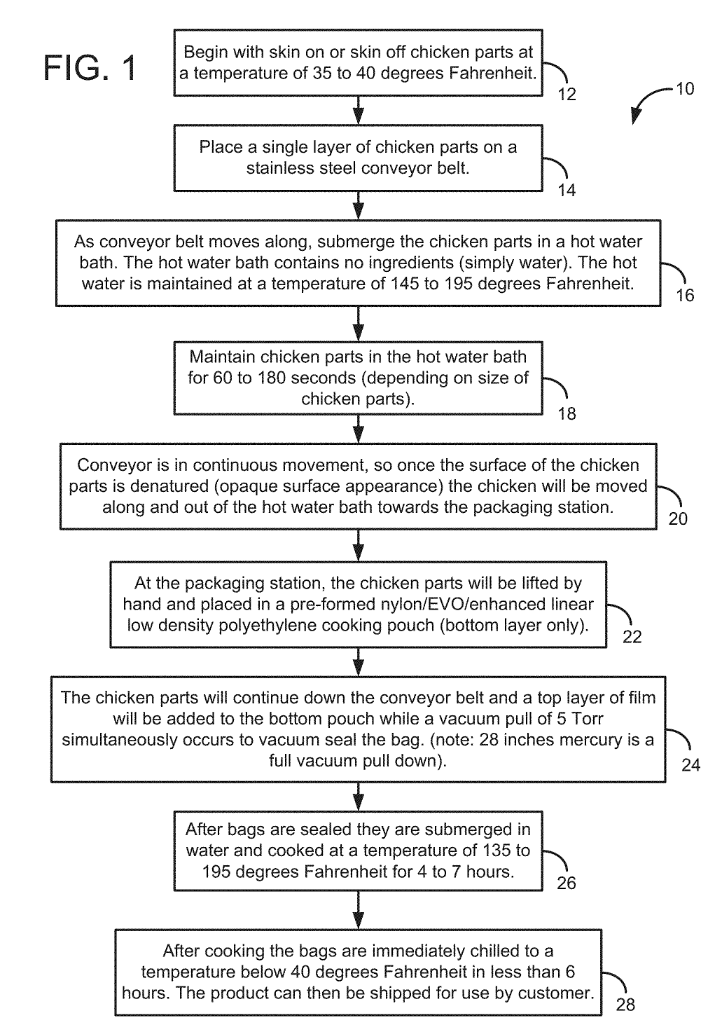

The present invention provides a method and apparatus for cooking or processing batches of chicken pieces that do not stick together upon completion of cooking. FIG. 1 shows a flowchart 10 of the steps of the method of the present invention. Provide a batch of skin-on or skin-off chicken parts at a temperature of 35° F. to 40° F. 12. Place a single layer of chicken pieces on a stainless steel conveyor belt 14 and activate the conveyor belt to move the pieces through a hot water bath at a temperature from about 145° F. to about 195° F. 16. In a preferred form of the invention, the water bath will be 100% water without any additives. Also, preferably, the chicken pieces are fully submerged in the water bath. The chicken pieces are in the water bath 18 for an effective period of time until a portion of the outer layer of the chicken pieces is opaque or denatured 20. In one preferred form of the method, in step 18 the chicken pieces are in the water bath for a period of about 60 seconds to about 180 seconds, more preferably from about 80 seconds to about 160 seconds, and most preferably from about 90 seconds to about 160 seconds, or any range or combination of ranges therein. Preferably, the conveyor belt will run continuously 20 carrying the denatured chicken pieces out of the water bath to a packing station 22.

At the packing station, the chicken pieces will be placed in a flexible pouch 24 preferably of a polymeric material capable of being submerged in a hot water bath for an effective period of time to cook the chicken pieces. In one form of the invention, the pouch is formed in situ around the chicken pieces by placing the chicken pieces on a surface of one sidewall 24 of the container, placing the other sidewall on top of the chicken pieces and sealing three peripheral edges to form a pouch with an open end and then vacuum sealing the open end to form a sealed container. It is contemplated, in another form of the invention of first forming the pouch, inserting the chicken pieces into the pouch and then vacuum sealing the open edge to form a sealed container.

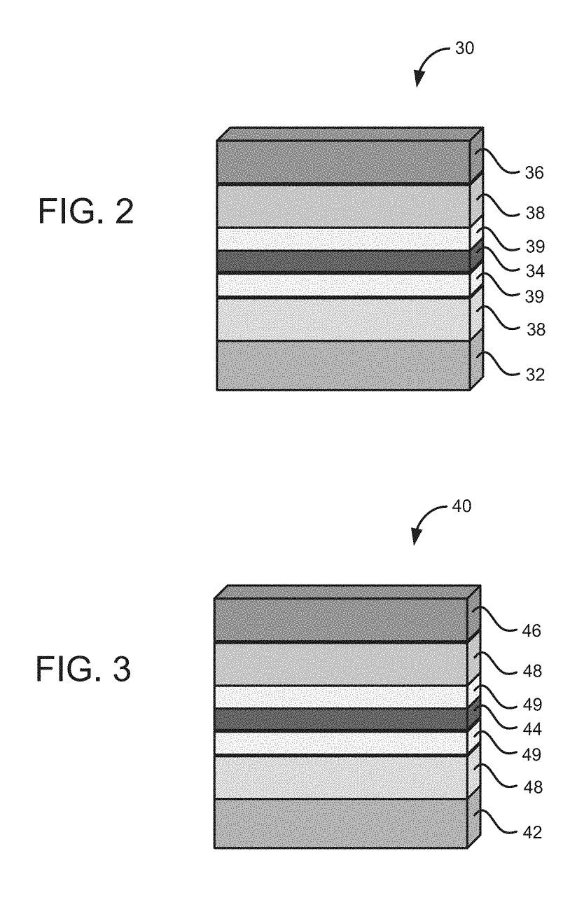

The first sidewall and the second sidewall can be of the same or different material. The first sidewall and the second sidewall can be a monolayer film, a multiple layer film, or a multiple ply film. The monolayer film can be of a single polymeric material or a blend of polymers. An exemplary multiple layer film is shown in FIGS. 2 and 3. Each of the layer(s) of the film is attached to adjacent layer(s) in face-to-face contact. The multiple layer film structure can have numerous layers such as two to ten layers, for example. The multiple ply film can have two or more individual plies sealed along a peripheral edge without the facing surfaces of the plies being connected. Similarly, the multiple ply film can have from two to ten plies, for example.

In one preferred form of the invention, the pouch will be fabricated from the same material on both sidewalls. A single web of material can be folded over and the free edges sealed to form a pouch and a sealed container. In another form of the invention, the first sidewall will be made from a different material from the second sidewall. The first sidewall could be made from a monolayer structure and the second sidewall could be made from a multiple layer structure or a multiple ply structure or any combination of the film structures described herein.

FIGS. 2 and 3 show two examples of suitable multiple layer structures. FIGS. 2 and 3 show a multiple layered structure 30, 40 having a first outer layer of a polyamide 32, 42, a core layer of an oxygen barrier material 34, 44 and a second outer layer 36, 46 of a polyolefin. Tie layers 38, 48 can be used to attach the core layer 34, 44 to the polyamide layer 32, 42 and the polyolefin 36, 46 to the opposite side of the core layer 34, 44. Suitable polyamides include nylons including nylon_{6,6}, nylon₆, as well as other nylons well known to those of ordinary skill in the art. Suitable oxygen barrier materials include ethylene vinyl alcohol (EVOH) or other materials well known to those of ordinary skill in the art. Suitable polyolefins include homopolymers or copolymers formed from monomers selected from ethylene, propylene, butene, hexene and octene. In one preferred form of the invention, the polyolefin is a homopolymer of ethylene including low-density polyethylene and high density polyethylene. In another preferred form of the invention, the polyolefin is a copolymer of ethylene with butene, hexene or octene and includes linear low-density polyethylene (LLDPE), and ultra-low density polyethylene. Most preferably, the polyolefin is an LLDPE.

In another preferred form of the invention the pouch will be formed from a first layer or top layer 30 and a second or bottom layer 40 that is different from the first layer. FIG. 2 shows an exemplary top layer of a multiple layer film having consecutive layers from a contact layer to an outside layer of: proprietary sealant layer 36/tie 38/nylon 39/EVOH 34/nylon 39/tie 38/nylon 32. The top layer 30 preferably has a thickness of about 90 microns. FIG. 3 shows an example of a bottom layer 40 of a multiple layer film having consecutive layers from a contact layer to an outside layer of: proprietary sealant layer 46/tie 48/nylon 49/EVOH 44/nylon 49/tie 48/nylon 42. Preferably, the bottom layer 40 has a thickness of about 225 microns.

Depending on the pouch formation process, the bottom layer supporting chicken pieces, or a pouch containing chicken pieces are placed on a conveyor belt to a station where a top layer of film is placed over the bottom layer and a peripheral portion is sealed to form the pouch in situ about the chicken pieces while a chamber of the pouch (either formed in situ or pre-formed) is placed under vacuum to remove the air 24. Preferably the top layer is joined by heat sealing along an open edge of the pouch and a vacuum is applied to a chamber of the pouch of 5 Torr until an internal vacuum of the pouch of 28 inches of mercury is reached to define a full vacuum pull down. The pouch is heat sealed to form a sealed container 24. Standard vacuum sealing machinery can be used as is well known to those or ordinary skill in the art.

The sealed container is submerged in a heated water bath 26 at a temperature from about 135° F. to about 195° F., more preferably about 140° F. to about 190° F. and most preferably from about 145° F. to about 185° F. or any range of combination of ranges therein. The water bath is maintained at a constant temperature of four the seven hours 26 at which time the chicken pieces are fully cooked where they have an internal temperature from about 135° F. to about 165° F. The water bath could also by cycled through a series of temperatures within the ranges cited and held at specific temperatures for a period of time or change continuously up and down between or among several temperatures.

The sealed container is then removed from the heated water bath 28 and placed in a refrigerated environment or a cooling water bath to bring the sealed container to a temperature of 40° F. in less than six hours. The sealed container can then be shipped for use by a customer 28.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

We claim:

1. A method for cooking a batch of chicken pieces comprising:
providing a plurality of chicken pieces at about 40° F.;
submerging the plurality of chicken pieces in a first heated water bath until a portion of the outer surface of the chicken pieces is denatured;
placing the plurality of opaque chicken pieces into a flexible pouch;
applying vacuum to the flexible pouch and sealing the pouch to form a sealed container; and
submerging the sealed container in a second heated water bath at a temperature of from about 135° F. to about 195° F. for an effective period of time to fully cook the chicken pieces.

2. The method of claim 1 wherein the heated water bath is at a temperature from about 145° F. to about 195° F.

3. The method of claim 1 wherein the flexible pouch has a first outer layer of a polyamide, a core layer of an oxygen barrier material and a second outer layer of a polyolefin.

4. The method of claim 1 wherein the step of applying a vacuum comprises applying a vacuum pull of 5 Torr.

5. The method of claim 4 wherein the desired vacuum within the sealed container is 28 inches of mercury.

6. The method of claim 1 wherein the chicken pieces are cooked until they reach an internal temperature of from about 135° F. to about 165° F.

7. The method of claim 1 wherein the chicken is in the first heated water bath for a period of time from about 60 seconds to about 180 seconds.

8. A method for cooking a batch of chicken pieces comprising:
providing a plurality of chicken pieces at about 40° F.;
submerging the plurality of chicken pieces in a first heated water bath until a portion of the outer surface of the chicken pieces is denatured;
placing the plurality of opaque chicken pieces onto a first flexible film;
placing a second flexible film over the plurality of opaque chicken pieces and connecting to the first film to define a flexible pouch;
applying vacuum to the flexible pouch and sealing the pouch to form a sealed container; and
submerging the sealed container in a second heated water bath at a temperature of from about 135° F. to about 195° F. for an effective period of time to fully cook the chicken pieces.

9. The method of claim 8 wherein the method further comprises placing the first layer of film on a conveyor belt.

10. The method of claim 1 wherein the step of connecting comprises heat sealing.

11. The method of claim 8 wherein the first flexible film is a multilayer structure having a layer of a polyamide, a core layer of an oxygen barrier material and a second outer layer of a polyolefin.

12. The method of claim 8 wherein the step of applying a vacuum comprises applying a vacuum pull of 5 Torr.

13. The method of claim 12 wherein the desired vacuum within the sealed container is 28 inches of mercury.

14. The method of claim 8 wherein the chicken pieces are cooked until they reach an internal temperature of from about 135° F. to about 165° F.

15. The method of claim 11 wherein the second flexible film is a multilayer structure.

16. The method of claim 15 wherein the second flexible film has a layer of a polyamide, a core layer of an oxygen barrier material and a second outer layer of a polyolefin.

17. The method of claim 8 wherein the first film is a monolayer.

18. The method of claim 8 wherein the first film is a multiply.

19. The method of claim 11 wherein the oxygen barrier material is an ethylene vinyl alcohol copolymer.

20. The method of claim 11 wherein the polyamide is a nylon_{6,6}, or a nylon₆
